(19) United States
(12) Patent Application Publication
(10) Pub. No.: US 2006/0037261 A1
(43) Pub. Date: Feb. 23, 2006

(54) Window cover system

(76) Inventors: William J. Callahan, Kingston, MA (US); Paul N. Winslow, Carver, MA (US)

Correspondence Address: LAMBERT & ASSOCIATES, P.L.L.C., 92 STATE STREET, BOSTON, MA, 02109-2004, US

(21) Appl. No.: 10/922,562

(22) Filed: Aug. 20, 2004

(51) Int. Cl. E06B 3/00; E06B 3/964

(52) U.S. Cl. 52/204.61; 52/204.5

(57) ABSTRACT

Provided is a window cover system designed to eliminate the problems related to windows that do not provide a proper barrier to the outside, nor a capable retainment system for the inside climate. The window cover system includes a flange and retainer system that is easily attached to a window casing by means of screws, and a snap on cover. The cover can be comprised of plastic, tinted or colored, or made of a screen-type material. The window cover system of the present invention may be installed by one individual, quickly, efficiently, and at a low cost.

### BACKGROUND OF THE INVENTION

1. Field of the Invention

This invention relates generally to the field of home improvement and more particularly to a specialized window cover system.

2. Description of the Related Art

Buildings that include windows and similar accesses are designed to admit light, air and sound, while permitting those inside to view the outside world from the comfort and security of the indoors. However, because windows comprise intentional gaps within a building's structural integrity, their proper function is imperative. Too often windows do not function as they are intended. The reasons for this include improper installation, disrepair, or simply age. The results can be quite costly to the building owner or residents.

One function of a window is to provide a barrier to whatever conditions exist externally to the building. Windows are normally designed to keep unwanted elements out of the building. For example, building owners generally wish to keep wind, snow, rain and the like out of their buildings. Other undesirable elements may include pests, odors, dust and other non-weather related factors. Windows that are not in good working order will not always protect against these conditions.

Windows also provide a means to keep desirable elements within the building or structure in. Examples include cool air during the summer and warm air during the winter. When windows are not working properly, heating and cooling costs can quickly skyrocket. Windows are also part of a structures overall vapor system. The phrase often used in the art is that a “house must be able to breath.” This refers to the proper flow of air in and out of structure, and the possibility of vapor build up within if the proper flow of air is not occurring. Peeling paint, mold and mildew growth are just some of the side effects that can result from a lack of proper air and moisture flow.

One solution to this problem is to repair any malfunctioning windows. However, this solution is not always feasible in that repairs may require removal of the entire window, incurring great expense and inconvenience to the building owner. Another solution is to replace the windows entirely. This solution, especially if more than one window requires replacement, is also extremely costly and inconvenient to those trying to utilize the internal portion of the building.

Prior art solutions have attempted to alleviate some of these problems by providing a means to cover the external portion of a window. While these attempts solve some of the problems associated with window malfunctions, they are either to costly to manufacture or overly complicated in structure, design and function. For example, the patent granted to Orth, U.S. Pat. No. 5,253,457 discloses a storm window mounting whose retention means is overly complicated and includes unnecessary decorative components. Other exterior and interior storm window coverings, such as the patents granted to Meadows, U.S. Pat. No. 4,333,284 and Rodriquez, U.S. Pat. No. 5,720,137 are again overly complicated and therefore impractical for the average building owner. The other failing of these prior art devices is that the complicated structure increases manufacturing costs to a level that prohibits and realistic entry into the retail market.

Therefore, what is required is a window cover system that is inexpensive to manufacture.

What is also required is a widow cover system that may be used on either the interior or exterior of a building.

What is further required is a window cover system that may be used to cover any size opening in a weather-proof manner.

What is also required is a window cover system that takes into account moisture removal within its enclosed portions.

What is also required is a window cover system that is versatile and adaptable to changing conditions and user needs.

What is also required is a window cover system that is quick and easy to install.

### BRIEF SUMMARY OF THE INVENTION

Accordingly, it is an object of the present invention to provide a window cover system that is inexpensive to manufacture and installs quickly and easily. It is also an object of the present invention to provide a window cover system that can adapt to different conditions and takes into account the possibility of moisture buildup within the enclosure.

The present invention comprises a window cover system that includes a flange portion permanently attachable around an opening, and also includes a retainer ring. A cover is then easily snapped onto the retainer ring providing a weather tight seal.

### BRIEF DESCRIPTION OF THE SEVERAL VIEWS OF THE DRAWINGS

These and other features, aspects and advantages of the present invention will become better understood with reference to the following description, appended claims, and accompanying drawings where:

FIG. 1 is a front view of the window cover system of the present invention.

FIG. 2 is a front view of the window cover system including the optional screened portion of the present invention.

FIG. 3 is a front view of the window cover system of the present invention including the downwardly angled top portion of the cover.

FIG. 4 is a side view of the window cover system of the present invention including the downwardly angled top portion of the cover.

FIG. 5 is a side view of a cutaway portion of the window cover system of the present invention displaying the cover and retainer attachment portions.

FIG. 6 is a front view of the window cover system of the present invention including first and second slidable sections.

FIG. 7 is a front view of the window cover system of the present invention including first and second slidable sections including screened portions.

### DETAILED DESCRIPTION OF THE INVENTION

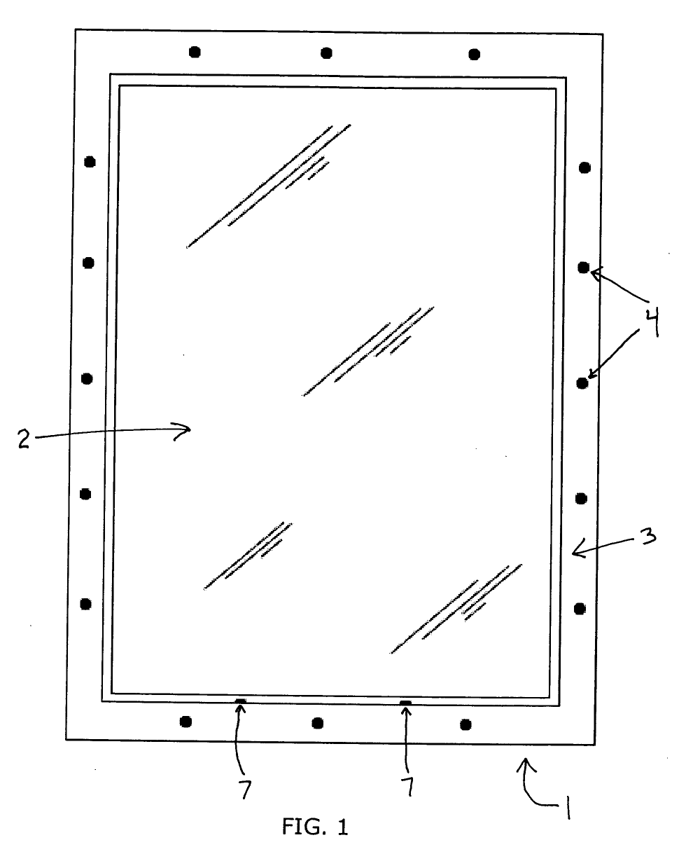

FIG. 1 illustrates the window cover system 1 of the present invention. Cover 2 is shown attached to frame 3. Frame 3 is secured to a window casing or other suitable area by means of screws, which may be inserted through screw holes 4. The exact number of screw holes 4 can vary as needed for the application. Also shown are moisture releasing cavities 7 located at the base of cover 2. The moisture releasing cavities 7 can vary in number, and their purpose is to release any moisture that may enter, or be found in, the enclosed portion of the window cover system 1 due to condensation or other means. Cover 2 may be made of plastic, and may be either transparent or opaque. Additionally, when cover 2 is comprised of plastic, or another material, it may include a tint or color, either of which may also include a degree of sunlight protection, including protection from ultraviolet rays. Cover 2 may also be comprised of glass or other materials, but plastic is the preferred embodiment to ensure ease of installation and low cost.

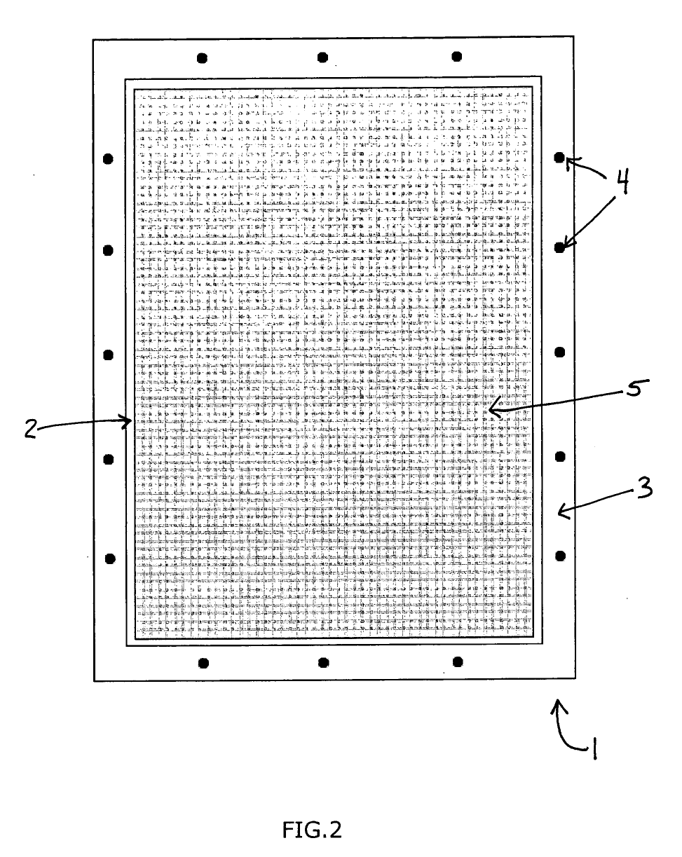

FIG. 2 illustrates a front view of the window cover system 1 of the present invention, including a screen portion 5. This embodiment allows the user to enjoy the benefits of a screened window, while retaining the versatility to quickly remove the screened portion cover and replace it with the cover 2 comprised of plastic. The screen portion 5 may comprise any suitable window style screen material as is known in the art.

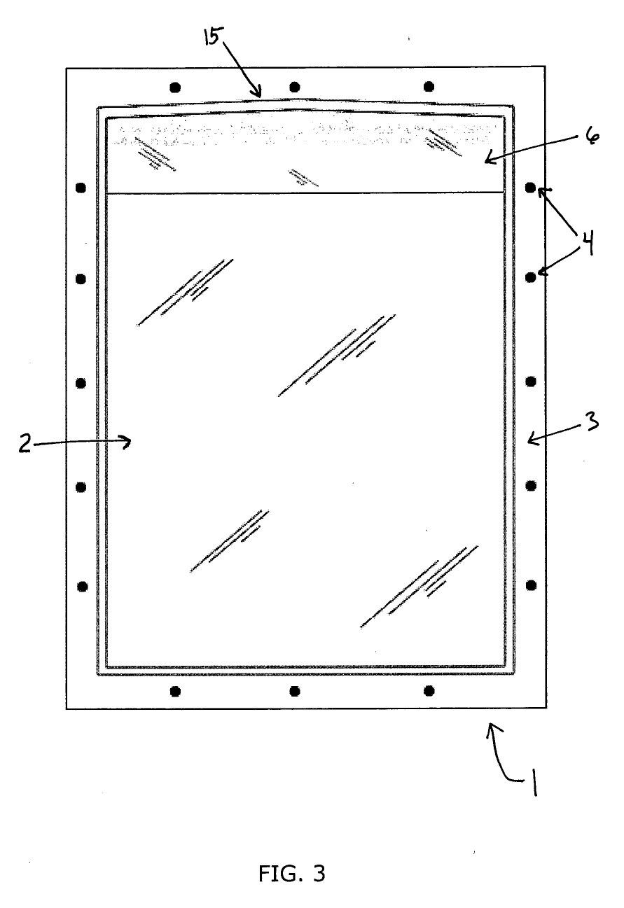

FIG. 3 illustrates a front view of the window cover system 1 including downwardly angled top portion 6 and upper peak 15. Top portion 6, in conjunction with upper peak 15, is designed to allow rain water and other precipitation to run down and to the side of the cover 2 instead of collecting, and causing potential water damage to the structure. The angles are also sufficient to prevent water and moisture from freezing during cold weather and causing damage to, or malfunction of, the window cover system 1.

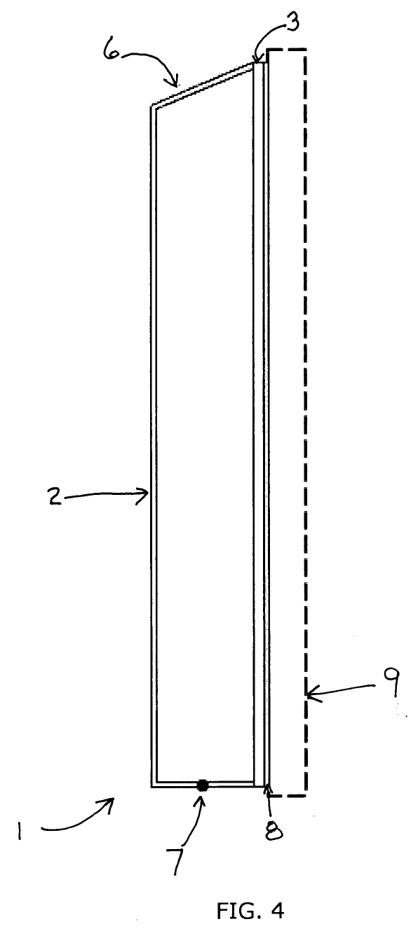

FIG. 4 illustrates a side view of a cutaway portion of the window cover system 1, including downwardly angled top portion 6. Also shown is moisture releasing cavity 7, located on the bottom portion of the window cover system. Gasket 8 provides a weather proof seal between the frame 3 and the window casing 9. Gasket 8 can be prefabricated as part of frame 3, or can comprise any suitable caulking, or gasket, as is known in the art. Caulking may also be applied to the seam created between the outer edge of frame 3 and window casing 9 to further enhance the weather proofing capability of the window cover system.

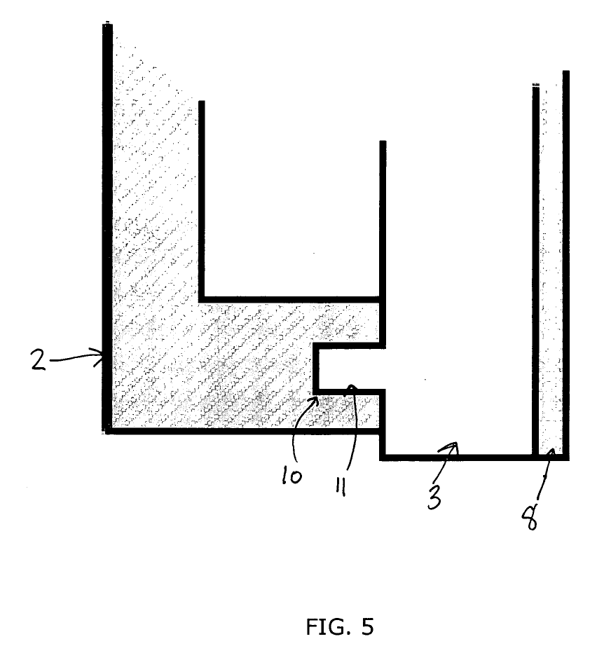

FIG. 5 displays an enlarged, cut away view of the window cover system of the present invention displaying cutaway portions of channel 10 and attachment ring 11. A key feature to the present invention is that the channel 10 and attachment ring 11 is that they are not overly complicated. The mating of the two provides a weatherproof seal, yet may be easily detached and a new type of cover applied as desired. Gasket 8 is also displayed on the rear portion of frame 3.

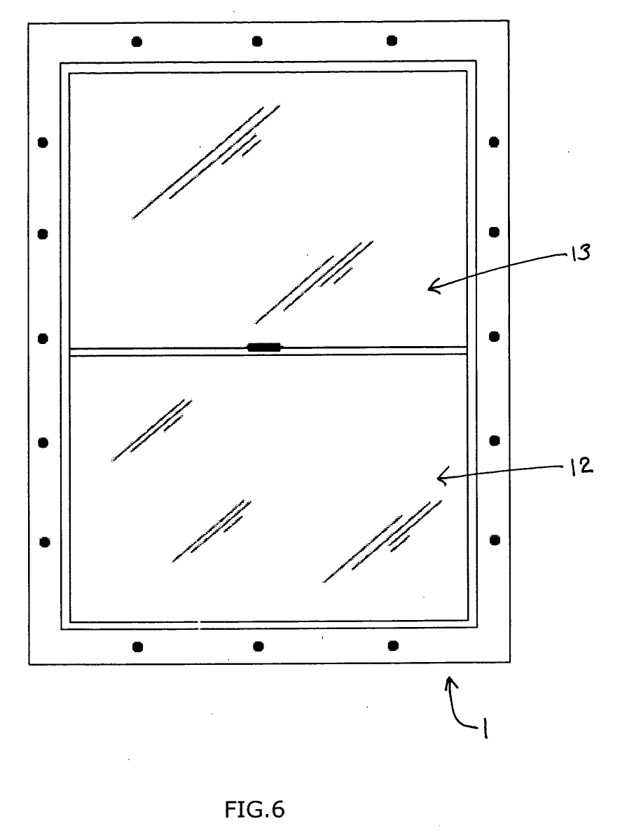

FIG. 6 illustrates a front view of the window cover system including a first section 12 and second section 13 that are slidably related. This type of configuration allows for a window cover that most closely resembles a typical window installation.

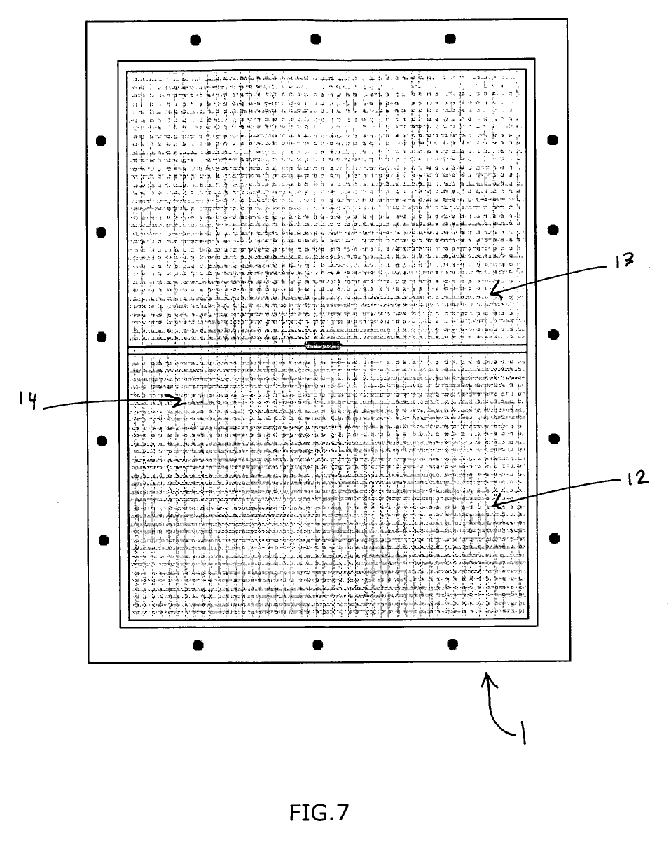

FIG. 7 illustrates a front view of the window cover system including a first section 12 and second section 13 that are slidably related and comprise a screened portion.

In the preferred embodiment, frame 3 is aligned and attached to a window casing via wood screws. The cover 2 with angled top portion 6 is attached to the attachment ring 11 by applying pressure to the cover 2. The space forming channel 10 is slightly smaller than attachment ring 11 and preferably is flexible enough to allow insertion of attachment ring 11. Although flexible enough to allow insertion of attachment ring 11, channel 10 must be sized sufficiently to allow for secure fastening of the attachment ring 11. The attachment ring 11 and channel 10 can be thought of as being analogous to a plastic type food storage lid and attachment portion of the food storage container. The channel 10 and attachment ring 11 may be substantially square or rounded, but this means of attachment between the cover 2 and frame 3 can be easily varied and understood by those of skill in the art.

Although the present invention has been described with reference to particular embodiments, it will be apparent to those skilled in the art that variations and modifications can be substituted therefore without departing from the principles and spirit of the invention.

What is claimed is:

1. A window cover system comprising:
a frame having a front side and a rear side; and
a cover attached to said frame.

2. The window cover system of claim 1, wherein said frame includes an attachment ring.

3. The window cover system of claim 2, wherein said cover includes a channel, wherein said channel is capable of releasably attaching to said attachment ring.

4. The window cover system of claim 3 wherein said frame includes a gasket affixed to said rear side of said frame.

5. The window cover system of claim 4, wherein said cover includes a downwardly angled top portion.

6. The window cover system of claim 5, wherein said downwardly angled top portion includes an upper peak.

7. The window cover system of claim 6, wherein said cover further includes areas defining at least one moisture releasing cavity.

8. The window cover system of claim 7, wherein said frame includes attachment ports.

9. The window cover system of claim 7, wherein said cover includes a screen portion.

10. The window cover system of claim 7, wherein said cover is made from glass.

11. The window cover system of claim 7, wherein said cover comprises a substantially plastic material.

12. The window cover system of claim 10, wherein said cover is substantially opaque.

13. The window cover system of claim 10, wherein said cover is substantially clear.

14. The window cover system of claim 10, wherein said cover includes a light-reflective surface.

15. The window cover system of claim 10, wherein said cover includes a tinted portion.

16. The window cover system of claim 10, wherein said cover includes at least one color.

17. The window cover system of claim 7, wherein said cover comprises a first section and a second section, wherein said sections are slidably related.

18. The window cover system of claim 17, wherein said cover includes a screen portion.

19. A window cover system comprising:
a frame having a front side and a rear side, and wherein said frame also includes a gasket affixed to said rear side of said frame, and wherein said frame further comprises an attachment ring, and said frame includes attachment ports;
a cover, said cover comprises a substantially plastic material, wherein said cover includes a downwardly angled top portion, and said cover further includes portions defining at least one moisture releasing cavity, wherein said at least one moisture releasing cavity is located on a bottom portion of said cover, and wherein said cover includes a channel, wherein said channel is capable of releasably attaching to said attachment ring.

20. The window cover system of claim 19, wherein said cover further comprises screen portions.

21. A method for covering a window comprising the steps of:
attaching a rectangular frame to a window casing, wherein said frame includes a gasket on a rear side of said frame, and wherein said frame includes an attachment ring on a front side of said frame;
affixing a cover to said frame by means of a channel capable of mating with said attachment ring of said frame, wherein said cover includes a downwardly angled top portion, and said cover further includes portions defining at least one moisture releasing cavity, wherein said at least on moisture releasing cavity is located on a bottom portion of said cover.
